(19) United States
(12) Patent Application Publication
(10) Pub. No.: US 2009/0303254 A1
(43) Pub. Date: Dec. 10, 2009

(54) METHOD OF CONTROLLING A DISPLAYING OF A GRAPHICAL OBJECT ON A DISPLAY OF A MOBILE ELECTRONIC DEVICE AND MOBILE ELECTRONIC DEVICE

(75) Inventor: Daniel BROMS, Lund (SE)

Correspondence Address: HARRITY & HARRITY, LLP, 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 12/134,459

(22) Filed: Jun. 6, 2008

(51) Int. Cl. G09G 5/00; H04B 1/38

(52) U.S. Cl. 345/660; 455/566

(57) ABSTRACT

The present invention provides a mobile electronic device comprising a display for displaying an image and an input unit comprising plural keys. The mobile electronic device is equipped with a control unit for controlling the displaying of the image. The present invention further provides a method of controlling a displaying of a graphical object on display of a mobile electronic device.

### FIELD OF THE INVENTION

The present invention relates to mobile electronic devices, such as cellular phones, personal digital assistants or hand-held computing devices, and to a method of controlling a displaying of a graphical object on a display of a mobile electronic device.

### BACKGROUND OF THE INVENTION

In recent years, mobile electronic devices are becoming more and more versatile. As an example, many of today's mobile electronic devices can be used for browsing through internet web pages. Many of these web pages are designed to be displayed on a desktop-size screen, yet mobile electronic devices are often provided with much smaller displays, e.g. measuring only several centimeters in diameter. Accordingly, browsing a large web page on such a mobile electronic device is rather complicated and uncomfortable.

For browsing a large web page, mobile electronic devices are known which use a so-called smart fit feature for converting web pages, so that they can be displayed with the same width as the width of the available display. In such a display mode, text on a web page can generally not be read, as it is too small. When leaving the smart fit mode, the user of the mobile electronic device has to scroll both up/down and left/right in order to see the complete web page (pan mode). This is generally done by using a curser or the like. Accordingly, a user has to actuate several control elements in order to reach the desired location on the web page. Using a pan and zoom mode is rather inconvenient, as the user is required to operate a small cursor on the display generally using a rather small control element, such as a rocker or a joystick-like control. As not every user is trained for such a delicate operation of the device, the browsing of a large web page on conventional mobile electronic devices is rather difficult, in particular for such users. The same holds true for browsing other data content such as images or large maps, which generally do not provide enough detail when displayed as a whole, yet are rather inconvenient to browse when displayed in an enlarged format. Accordingly, there is the need of providing a better control of the displaying of graphical objects on a mobile electronic device. In particular, there is a need of facilitating the browsing of such a graphical object and of enhancing the user control of the displaying. It is desirable to reduce the number of required user inputs in order to reach a desired display of an object. It is also desirable to improve the ergonomics of a mobile electronic device as regards the displaying of graphical objects.

### SUMMARY OF THE INVENTION

The present invention provides a mobile electronic device, a processor readable medium and a method of controlling a displaying of a graphical object on a display of a mobile electronic device.

According to a first aspect of the invention, a mobile electronic device comprises a display for displaying an image and an input unit comprising plural keys. A control unit for controlling the displaying of the image is further provided. The control unit is configured to associate at least two regions of a graphical object comprised in an image displayed on the display each with a key of the input unit. Further, the control unit is configured to enlarge one of said regions of the graphical object in the displayed image upon activation of the associated key. Accordingly, by activating a key associated with a region of the graphical object, an enlarged display of the selected region is provided. A user of the mobile electronic device is thus provided with a better control over the displaying of the graphical object.

According to an embodiment of the invention, the control unit is configured to divide the displayed graphical object into at least four regions. Each of these four regions is then associated with a key of the input unit. Just as an example, the control unit may be configured to divide the displayed graphical object into an array of three times four regions. A different key of the input unit may then be assigned to each of these regions.

According to another embodiment, the keys associated with the regions comprise numeric keys of the mobile electronic device. These may for example be pure numeric keys, or alphanumeric keys. According to a further embodiment, the keys comprise numeric keys as well as a hash key and a star key of the mobile electronic device. The control unit is then configured to associate each of said keys with a region of a displayed graphical object. Just as an example, ten numeric keys (0-9), a hash key and a star key may be assigned to twelve different regions of the graphical object. A user may thus be enabled to select and enlarge a particular region of the displayed graphical objects by only one user input.

According to a further embodiment, the graphical object comprises at least part of an object selected from a group comprising a web page, a map and an image.

According to yet another embodiment of the invention, the mobile electronic device is implemented as a cellular phone, a personal digital assistant, a personal navigation device, a hand-held computing device, a portable computer, a hand-held communication device, a digital camera or a portable multimedia player. Other implementations are of course also possible. The implementation of the invention in such a device is particularly useful due to the restrictions to screen size for the mentioned devices.

According to a further embodiment of the invention, the control unit is configured to repeat said associating and said enlarging for a part of the graphical object displayed enlarged in the image. As an example, a user may select a region which is then displayed enlarged, the user being given the opportunity to again enlarge a region of the displayed part of the graphical object. In particular, the control unit may be configured to repeat the associating of at least two regions of the graphical object comprised in the image each with a key of the input unit. These regions may cover the part of the graphical object that is displayed enlarged. The control unit is then further configured to repeat the enlarging of one of said regions of the graphical object in the displayed image upon activation of the associated key. The steps may be repeated until the part of the graphical object comprised in the image has a predetermined scale. The steps of associating regions of the graphical object with keys and of enlarging a region upon actuation of the associated key may thus be repeated over and over until for example text of a web page can be read, or features of a map can be recognized, or an image resolution corresponds to a display resolution of the mobile electronic device. Accordingly, a user may control the display of a desired area of the graphical object at a desired scaling with only few actuations of the associated keys.

According to another aspect of the invention, a method of controlling a displaying of a graphical object on a display of a mobile electronic device is provided. The mobile electronic device comprises an input unit with a plurality of keys. The method comprises the displaying of an image on the display, and the associating of at least two regions of a graphical object comprised in the image each with one of said keys. One of said regions of the graphical object in the displayed image is then enlarged upon activation of the associated key. A user is thus provided with an enhanced control of displaying the graphical object.

In an embodiment, the enlarging of a region comprises a scaling of the region of the graphical object to a size substantially equal to a size of the graphical object comprised in the image before the enlarging. As an example, the graphical object may be displayed in a certain area of the image before enlarging, whereas after enlarging, the selected region is then displayed in the same area. It should be clear that when enlarging the region, parts of the region may be cropped or parts of regions surrounding the selected region may still be displayed after enlargement.

According to another embodiment, the method further comprises a dividing of the part of the graphical object displayed in the image into at least four regions. Each of the at least four regions is associated with one of the keys. A high degree of user control over the enlargement of regions of the graphical object is thus achieved.

According to another embodiment, the method further comprises the step of displaying a boundary of at least one of said regions in the image. The selection of a region by a user may thus be facilitated.

According to a further embodiment, the method further comprises the step of scaling the graphical object to a size such that the graphical object is visible in its entirety in the image. The user may thus be provided with an overview over the graphical object, which may facilitate zooming into the graphical object by selecting and enlarging a region of the graphical object.

According to a further embodiment, the regions have a square shape. The regions may also have other shapes such as rectangular shapes, or they may have a shape with an aspect ratio corresponding to the aspect ratio of the graphical object displayed in the image.

According to a further embodiment, the keys associated with the regions comprise numeric keys of the mobile electronic device. The keys associated with the regions may for example comprise numeric keys only, yet they may also comprise numeric and non-numeric keys. As mentioned above, the graphical object may for example be a web page, a map or an image.

According to yet another embodiment of the invention, the method is performed as part of zoom display mode of the mobile electronic device. In said zoom display mode, the steps of associating the keys with the regions of the displayed graphical object and of enlarging one of said regions of said graphical object in the displayed image upon activation of the associated key are repeated for an enlarged region of said graphical object. They may for example be repeated until the graphical object has a predetermined scaling in the image or until the zoom display mode is quit. As an example, a user may first be provided with an overview of the graphical object, of which a region is displayed and enlarged upon actuation of the associated key, the associating and enlarging being then repeated for the enlarged region until the desired detail or zoom factor is reached.

According to a further aspect of the invention, a method of controlling a displaying of a graphical object on a display of a mobile electronic device comprises the step of displaying an image comprising at least part of the graphical object rendered at a first scale on said display. The method further comprises the step of associating at least two regions of the graphical object comprised in the image each with one of said keys. The mobile electronic device is then operated so as to enable the user to select one of the regions by actuating the associated key for displaying an image comprising at least part of the graphical object corresponding to the selected regions rendered at a second scale. The second scale is generally larger than the first scale. Accordingly, an enlarged display of the selected region of the graphical object is provided.

According to a further aspect, a processor readable medium having processor executable instructions for controlling a displaying of a graphical object on a display of a mobile electronic device is provided. When the processor executable instructions are executed on a processor of the mobile electronic device, they perform the steps of displaying an image comprising at least part of the graphical object on the display, associating at least two regions of the graphical object comprised in the image each with a key of an input unit of the mobile electronic device and enlarging one of the regions of the graphical object in the displayed image upon actuation of the associated key. The instructions for performing the above-mentioned method steps may be furthermore provided in the form of a computer program product. Such a computer program product may be distributed on a data carrier, or by other means, such as through a data transfer network, such as the internet.

Those skilled in the art will appreciate that one or more elements of the above-described embodiments may be combined. Features of the above-described embodiments and aspects of the invention may be combined to form new embodiments.

The foregoing and other features and advantages of the invention will become further apparent from the following detailed description of illustrative embodiments when read in conjunction with the accompanying drawings. The detailed description and drawings are merely illustrative of the invention rather than limiting.

### BRIEF DESCRIPTION OF DRAWINGS

Embodiments of the present invention are illustrated by the accompanying figures, wherein:

FIG. 1 shows a schematic block diagram of an embodiment of a mobile electronic device according to the invention;

FIG. 2 shows a schematic drawing of an embodiment of a mobile electronic device according to the invention;

FIG. 3 shows a flow diagram of an embodiment of a method according to the invention;

FIG. 4A-4C are schematic drawings illustrating the enlarging of a region of a graphical object comprised in an image displayed on a display of a mobile electronic device.

Like reference symbols in the drawings indicate like elements.

### DETAILED DESCRIPTION OF THE INVENTION

A mobile electronic device according to an embodiment of the invention provides an enhanced control of the displaying of a graphical object. In particular, it enables a user to zoom to a desired position of the graphical object by pushing only a small number of buttons. The device provides a zoom function for graphical content, which may be used for displaying web pages, images, maps and the like. A precise zooming is achieved without the need for a delicate control, i.e. the placement of a small cursor on the display of the mobile electronic device.

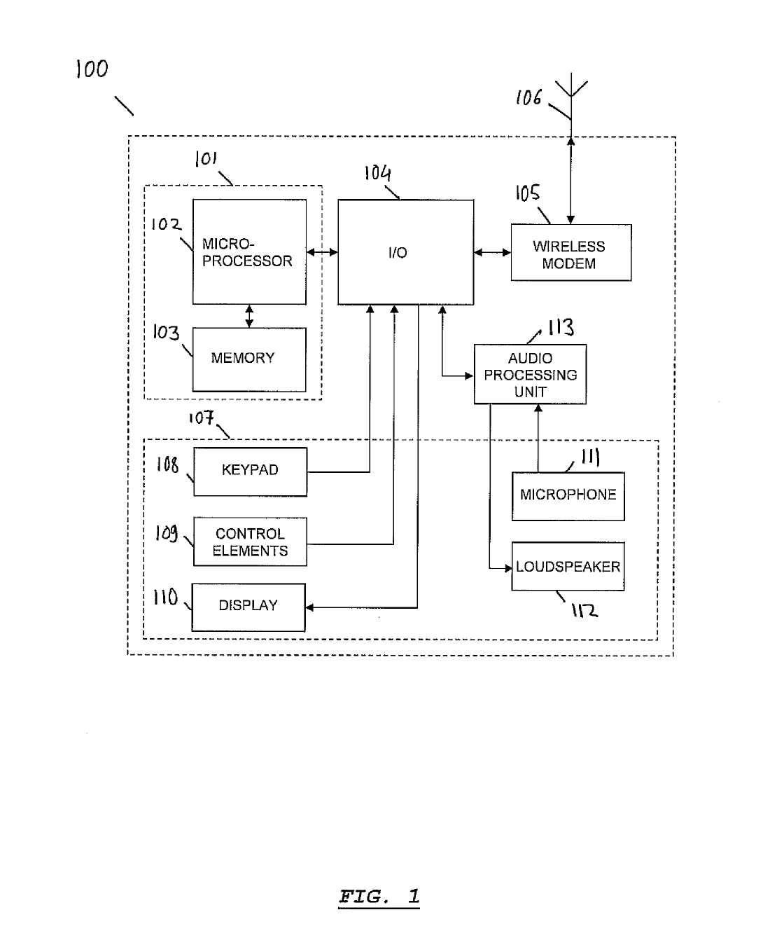

The block diagram of FIG. 1 depicts an embodiment of a mobile electronic device according to the invention. The general operation of an exemplary mobile electronic device 100 will be described with reference to FIG. 1. Mobile electronic device 100 comprises a control unit 101 with a microprocessor 102 and memory 103. Microprocessor 102 controls the operation of the mobile electronic device 100 according to programs stored in memory 103. Microprocessor 102 may be implemented as a single microprocessor or as multiple microprocessors in the form of a general purpose or special purpose microprocessor, or of one or more digital signal processors. Memory 103 may comprise all forms of memory, such as random access memory (RAM), read only memory (ROM), non-volatile memory such as EPROM or EEPROM, flash memory or hard drive. Some of these types of memory may be removable from the mobile electronic device 100, e.g. flash memory cards, while others may be integrated for example with microprocessor 102. Memory 103 may for example store programs which enable the mobile electronic device 100 to display images, web pages or maps on a display of the device 100. Microprocessor 102 interfaces several components of the mobile electronic device 100 via input/output unit 104. Microprocessor 102 controls wireless modem 105, which may receive data from or transmit data through a wireless communication network via antenna 106. Wireless modem 105 may for example comprise a fully functional cellular radio transceiver. Such a radio transceiver may receive or transmit data through a communication network, which may operate according to any known standard, such as the global system for mobile communications (GSM), TEA/EIA-136, CDMA ONE, CDMA 2000, UMTS, or wideband CDMA. Wireless modem 105 may also be configured for packet based data transmission, e.g. over a general packet radio service (GPRS) mobile data service. In other embodiments, wireless modem 105 may be implemented as a wireless local area network transceiver, a Bluetooth transceiver, an optical transceiver or the like. Via wireless modem 105, microprocessor 102 may request data from a data transmission network, it may for example request a web page from the internet.

Microprocessor 102 further interfaces user interface unit 107 via input/output unit 104. User interface unit 107 comprises a keypad 108 and other control elements 109, which constitute an input unit. Keypad 108 and control elements 109 may be used by a user to control mobile electronic device 100 and to enter information. Keypad 108 may comprise numeric, alphanumeric and other keys, e.g. special purpose keys, a hash key, a star key and other function keys. The keys may be used to enter a telephone number, or to type in a text (e.g. for a short message). Keypad 108 may also be implemented as a full keyboard, e.g. of a palm- or a laptop computer. The other control elements 109 may for example comprise joystick-like control elements, a two-way or four-way rocker, rotary control elements and the like, which may for example be used to browse through function menus of the mobile electronic device 100 and to activate functions. User interface unit 107 further comprises display 110, which may, among other data, display such function menus. By using keypad 108, a user may for example enter a particular web address, in response to which microprocessor 102 requests the web page via wireless modem 105. When receiving the corresponding data, microprocessor 102 may render an image of the web page in a size so that it can be displayed in its entirety on display 110. This may be performed by browser software running on microprocessor 102 and being stored in memory 103. Yet such a rendering of an image may also be performed by a separate graphics processor (not shown). In another example, image processing software running on microprocessor 102 may render an image stored in memory 103, and provide the rendered image for display on display 110. As yet another example, map data may be stored in memory 103, and map application software running on microprocessor 102 may render an area covered by said map data and provide the rendered image via input/output unit 104 to display 110. Images and map data may of course also be obtained via wireless modem 105.

In operation, mobile electronic device 100 may for example display an image on display 110 which comprises a graphical object such as a web page, a map or a picture, e.g. captured by an internal camera, or part thereof. Control unit 101 is now configured so as to associate several keys of keypad 108 each with a different region of the graphical object displayed on display 110. The displayed graphical object, e.g. a web page or a part of a web page, may be divided into two times two regions, or three times three regions, or any other suitable subdivision, which may be determined by user input, or preset as a parameter. To each of these regions, control unit 101 assigns a different key of keypad 108. An actuation of one of said keys is then detected by control unit 101. In response to detecting such an actuation, control unit 101 enlarges the associated region. Control unit 101 rerenders for example the part of the graphical object corresponding to the selected region to a size which corresponds to the area which was taken up by the graphical object before enlargement. This basically means that upon actuation of said key, the display zooms to the selected region. When a graphical object or an enlarged part thereof is displayed on display 110, control unit 101 may be further configured to provide a pan mode, in which a user may adjust the part of the graphical object displayed enlarged on display 110 by translating the graphical object. The positioning of the graphical object may for example be controlled with one of the control elements 109. The above steps may be carried out by microprocessor 102 according to instructions stored in memory 103 of control unit 101.

A zoom-out function can furthermore be assigned to one of the keys of keypad 108, or to a control element 109. Upon actuation of said function, the graphical object is displayed at a smaller scale, meaning that a larger part of the graphical object is displayed. Zoom-in and zoom-out factors may be the same, so that upon subsequent actuation of both functions, the size of the graphical object displayed may return to the original size. Control unit 101 may be furthermore configured to provide a user with the possibility of performing subsequent zooming operations, e.g. by repeating the association of regions of the graphical object with keys of keypad 108, and of enlarging a region upon actuation of the associated key. A user may thus zoom to a desired zoom level, or until a predetermined scaling of the graphical object in the displayed image is reached, by repeatedly actuating keys of keypad 108.

Mobile electronic device 100 further comprises microphone 111 and loudspeaker 112. For voice communication over a mobile communication network, such as a UMTS or a GMS network, microphone 111 records the voice of a user of mobile electronic device 100, whereas loudspeaker 112 is provided for reproducing a received voice signal. Voice signals may be transmitted and received by a wireless transceiver (not shown) connected to input/output unit 104. The wireless transceiver may also be integrated with wireless modem 105 in one unit. Audio processing unit 113 converts a received digital voice signal to an analog voice signal and interfaces loudspeaker 112 for giving out the analog voice signal. Audio processing unit 113 further interfaces microphone 111 for digitizing a recorded analog voice signal and for providing the digitized voice signal via input/output unit 104 to microprocessor 102 for further processing.

Mobile electronic device 100 may for example be implemented as a cellular phone providing voice communication via microphone 111 and loudspeaker 112. A wireless transceiver may be integrated with wireless modem 105 so as to provide both mobile telephony as well as data transmission functionality. Using such a cellular phone, a user may for example capture a picture/image with an integrated camera (not shown), download a web page from the internet or display a map with an integrated navigation system. For these applications, zooming into a displayed graphical object, such as the web page, the captured image or the map, is desirable and may be performed by the control unit 101 as described above.

It should be clear that mobile electronic device 100 may comprise other components which are not shown for the purpose of clarity. Such components may for example comprise a camera unit, a navigation unit such as a GPS receiver, further data sources and the like, whereas other components are optional, such as microphone 111, loudspeaker 112, audio processing unit 113 or wireless modem 105. Mobile electronic device 100 may for example be implemented as a personal navigation device, which uses control unit 101 to enlarge regions of a graphical object in the form of a part of a map. Other implementations of mobile electronic device 100 include a personal digital assistant, a hand-held computing device, such as a palm-top computer or an organizer, a portable computer, a hand-held communication device, a digital camera and a portable multimedia player.

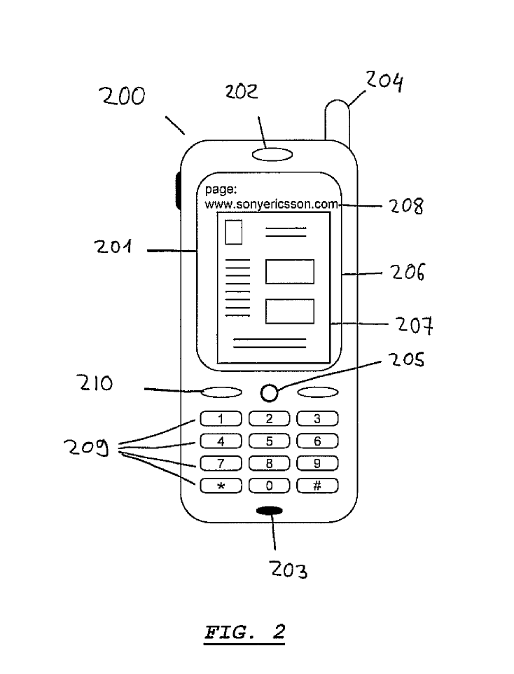

FIG. 2 shows a schematic drawing of an embodiment of a mobile electronic device according to the invention. In FIG. 2, the mobile electronic device is implemented as a cellular phone 200 comprising a display 201, a loudspeaker 202, a microphone 203 and an antenna 204. When displaying a web page on a conventional cellular phone, a control element such as the joystick-like control element 205 may be used to pan and zoom the web page. A cursor may be positioned on a downsized representation of the web page using control element 205, and upon actuation of another control, a region proximate to the cursor may be displayed enlarged.

Display 201 of cellular phone 200 of the present embodiment displays an image 206 comprising a graphical object 207 and an information or status line 208. Graphical object 207 corresponds to a web page which is rendered to a size so that it is visible in its entirety on display 201. Due to the limited size of display 201, text and images comprised in the web page, i.e. graphical object 207, cannot or only hardly be recognized. For providing an enlarged display of the graphical object 207, cellular phone 200 is operated in a zoom mode, in which the numeric or alphanumeric keys 209 are assigned to different regions of graphical object 207. Graphical object 207 comprised in image 206 may for example be divided into four, nine or twelve regions, which are then associated with the corresponding number of number keys 209. A person skilled in the art will appreciate that the keypad may comprise any possible configuration of keys, e.g. 2×6 numeric keys, and that accordingly, the graphical object may be divided into a corresponding number of regions. When actuating one of the number keys 209, the corresponding region of graphical object 207 is enlarged. It is enlarged so that it fills most of the display area occupied by graphical object 207. As the text may still not be readable by a user of cellular phone 200, the procedure is repeated and the user may further zoom into the graphical object 207 by actuating another key 209. These different levels of enlargement of the graphical object 207 may be designated as zoom levels. After several zoom-in operations, the web page will be provided at a scale suitable for reading, and accordingly, no further zooming may be provided. Control element 210 may further function as a zoom-out button, actuation of which results in a downscaling of the displayed graphical object, i.e. the moving to a lower zoom level.

Using the keys 209 for zooming operations has several advantages. First, the graphical object 207 may be subdivided into a relatively large number of regions, as a result of which a high zoom factor can be achieved even in one zooming operation. Further, the position of the graphical object which is displayed enlarged can be precisely determined by using the keys 209. It is not required to precisely position a cursor over the regions for which the zooming in is desired. Even without requiring such delicate and difficult positioning, a high degree of position control is achieved. The operation of the cellular phone 200 is thus greatly facilitated, in particular as no fine motor skills are necessary. Also, only one button needs to be actuated in order to zoom to the desired region. In contrast, when using a cursor, multiple buttons have to be actuated, first for moving the cursor, and finally for selecting the region. Accordingly, with the mobile electronic device of the present embodiment, zooming can be achieved faster. Further, no additional control elements are required.

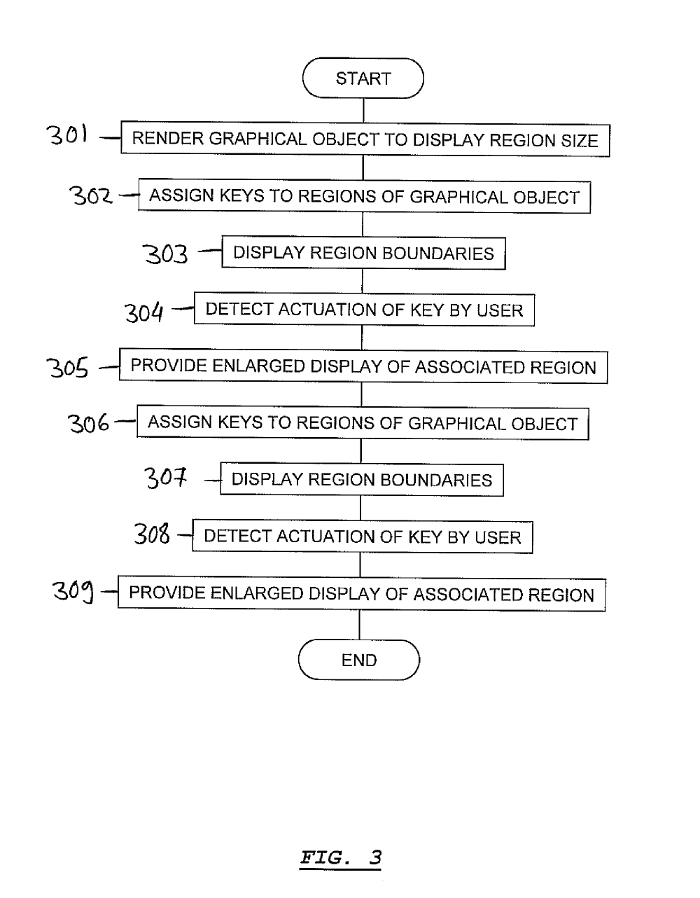

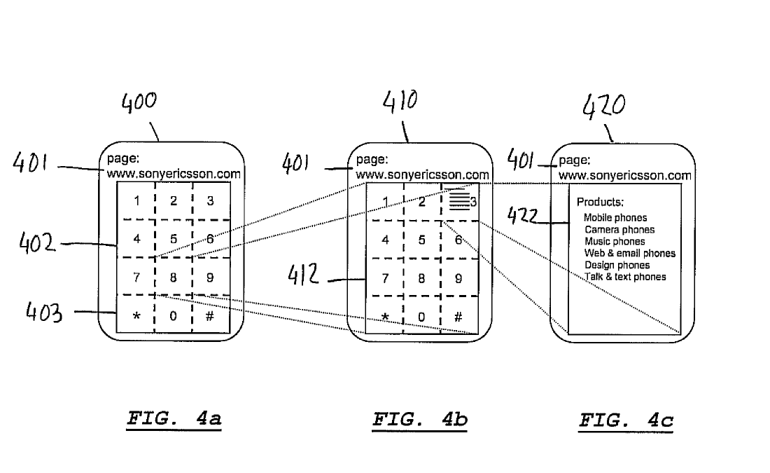

FIG. 3 shows a flow diagram of an embodiment of a method according to the invention. The method may be implemented on one of the above-mentioned devices. In a first step 301, a graphical object is rendered to a display region size, or to the size of an area designated for displaying the graphical object. With reference to FIG. 4A, an image 400 is shown, which comprises a status line 401, as well as a display area 402 for graphical object 403. The graphical object may be rendered to a size so that it fits into area 402. Image 400 may for example be displayed on display 201 of a cellular phone 200. The display area 402 may also comprise the entirety of image 400, or may be smaller, depending on the application. As said before, the graphical object may be a web page and it may be rendered so that its width fits the width of area 402, or that its height fits the height of area 402. Portions of the graphical object outside area 402 may be reached using a panning mode.

In the next step 302, keys of the input unit of the mobile electronic device are assigned to regions of the graphical object. Again referring to FIG. 4A, the graphical object 403 in area 402 is subdivided into twelve regions indicated by numerals 0-9, star and hash. The labels of the regions shown in FIG. 4A may or may not be displayed to a user of the mobile electronic device. The labels correspond to the keys, which are assigned to the regions designated by the labels. Providing the labels has the advantage that the user immediately knows which key to operate in order to enlarge the desired region. On the other hand, the display of the graphical object may become less clear when showing the labels. The twelve regions of the graphical object 403 are separated by dashed lines in FIG. 4A. These region boundaries are displayed in step 303. Displaying the region boundaries has the advantage that the user of the mobile electronic device knows in which region a particular position of the graphical object lies.

In step 304, an actuation of key by the user of the mobile electronic device is detected. In the example of FIG. 4, the user actuates the numeric key 8. Accordingly, the region associated with the numeric key 8 (i.e. the region with the label 8) is selected. In step 305, an enlarged display of the region associated with the actuated key is provided. Again referring to FIG. 4, the dotted lines indicate that the region with the label 8 is enlarged in image 410 of FIG. 4B. As can be seen, the display area 412 has a different aspect size than the region 8. Accordingly, region 8 may be cropped so that not all of region 8 is displayed in area 412 in image 410, or parts of the surrounding regions, e.g. of regions 0 and 5, may be displayed in area 412. Generally, region 8 is enlarged so that it covers most of area 412.

In a next step 306, keys are again assigned to displayed regions of the graphical object. With reference to FIG. 4B, region 8, which is displayed enlarged in image 410, is again subdivided into twelve regions. Number keys corresponding to the labels shown in FIG. 4B are again assigned to the regions. In steps 307, the region boundaries are displayed to the user, to facilitate the selection of a region.

The actuation of the key by a user is detected in step 308. In response to the actuation, an enlarged display of the region associated with the actuated key is provided in step 309. This situation is shown in FIG. 4C. In the example of FIG. 4, the user has actuated number key 3, in response to which region 3 of FIG. 4B is enlarged and displayed in image 420 of FIG. 4C. This situation is again illustrated by dotted lines. In the example of FIG. 4C, the scaling of the graphical object has now reached a level in which text comprised in the web page can be easily read in image 420. Accordingly, no further zooming is provided. The user may now use a pan mode for reaching another region, i.e. region 2 of FIG. 4B, by moving a cursor to that region. On the other hand, the user can be provided with the zoom-out functionality, upon operation of which he will return from the display of FIG. 4C to the display of FIG. 4B. He may then select a different region of the graphical object by again using the numeric key corresponding to the region which he would like to display in an enlarged format. By again operating the zoom-out function, he may return to the display of FIG. 4A. Another key may be provided with a functionality of moving directly from FIG. 4C to a display in which the graphical object is shown in its entirety. A person skilled in the art will appreciate that FIG. 3 shows only an example of an implementation of a method according to the invention, and that more zoom levels may be provided, or the method may continue again with step 302 after step 309. The method may e.g. loop through steps 302-305, until a predetermined scaling of the graphical object is reached.

It should be clear that the division of the graphical object into twelve different regions is only one possibility. The object may be divided in three by three, two by three or two by two regions, and the regions do not need to be rectangular. If larger keypads are used, the graphical object may also be divided into more regions. A person skilled in the art will appreciate that the keypad may comprise any possible configuration of keys, e.g. 2×6 numeric keys, and that accordingly, the graphical object may be divided into a corresponding number of regions. Further, in all stages of the zooming, a pan functionality may be provided, as well as a conventional zoom-in and zoom-out functionality. Further, the display areas 402, 412 and 422 do not need to have equal size, they may differ depending on the aspect ratio of the selected region, or depending on the application. As mentioned above, the present invention applies to any mobile electronic device that benefits from a zoom functionality. As such, the present invention is not limited to the specific configurations shown in FIGS. 1-4.

While specific embodiments of the invention are disclosed herein, various changes and modifications can be made without departing from the spirit and the scope of the invention. The present embodiments are to be considered in all respect as illustrative and non-restrictive, and all changes coming within the meaning and equivalency range of the appended claims are intended to be embraced therein.

What is claimed is:

1. A mobile electronic device, comprising:
a display for displaying an image;
an input unit comprising plural keys; and
a control unit controlling the displaying of said image;
wherein the control unit is configured to associate at least two regions of a graphical object comprised in an image displayed on said display each with a key of the input unit and to enlarge one of said regions of the graphical object in the displayed image upon activation of the associated key.

2. The mobile electronic device of claim 1, wherein the control unit is configured to divide the displayed graphical object into at least four regions each associated with a key of said input unit.

3. The mobile electronic device of claim 1, wherein the keys associated with said regions comprise numeric keys of the mobile electronic device.

4. The mobile electronic device of claim 1, wherein said keys comprise numeric keys as well as a hash key and a star key of the mobile electronic device, the control unit being configured to associate each of said keys with a region of the displayed graphical object.

5. The mobile electronic device of claim 1, wherein the control unit is configured to divide the displayed graphical object into an array of three times four regions.

6. The mobile electronic device of claim 1, wherein the graphical object comprises at least part of an object selected from a group comprising a web page, a map and an image.

7. The mobile electronic device of claim 1, wherein the mobile electronic device is a device selected from a group comprising a cellular phone, a personal digital assistant, a personal navigation device, a handheld computing device, a portable computer, a handheld communication device, a digital camera, and a portable multimedia player.

8. The mobile electronic device of claim 1, wherein, for a part of said graphical object displayed enlarged in said image, the control unit is configured to repeat said associating of at least two regions of the graphical object comprised in the image each with a key of the input unit and said enlarging of one of said regions of the graphical object in the displayed image upon activation of the associated key, until the part of the graphical object comprised in the image has a predetermined scale.

9. A method of controlling a displaying of a graphical object on a display of a mobile electronic device comprising an input unit with a plurality of keys, comprising the steps of:
displaying an image on said display;
associating at least two regions of a graphical object comprised in the image each with one of said keys; and
enlarging one of said regions of the graphical object in the displayed image upon activation of the associated key.

10. The method of claim 9, wherein the enlarging of a region comprises the scaling of the region of the graphical object to a size substantially equal to a size of the graphical object comprised in the image before the enlarging.

11. The method of claim 9, further comprising the steps of
dividing the part of the graphical object displayed in said image into at least four regions; and
associating each of said at least four regions with one of said keys.

12. The method of claim 9, further comprising the step of displaying a boundary of at least one of said regions in said image.

13. The method of claim 9, further comprising the step of scaling the graphical object to a size such that the graphical object is visible in its entirety in said image.

14. The method of claim 9, wherein said method is performed as part of a zoom display mode of said mobile electronic device, wherein said steps of associating the keys with the regions of the displayed graphical object and of enlarging one of said regions of said graphical object in the displayed image upon activation of the associated key are repeated for an enlarged region of said graphical object until the graphical object has a predetermined scaling in said image or until said zoom display mode is quit.

15. The method of claim 9, wherein said regions have a square shape.

16. The method of claim 9, wherein said keys associated with said regions comprise numeric keys of said mobile electronic device.

17. The method of claim 9, wherein the graphical object is at least part of an object selected from a group comprising a web page, a map and an image.

18. A method of controlling a displaying of a graphical object on a display of a mobile electronic device comprising an input unit with a plurality of keys, comprising the steps of:
displaying an image comprising at least part of said graphical object rendered at a first scale on said display;
associating at least two regions of the graphical object comprised in the image each with one of said keys; and
operating the mobile electronic device so as to enable a user to select one of said regions by actuating the associated key for displaying an image comprising at least part of the graphical object corresponding to said selected region rendered at a second scale larger that the first scale, so as to provide an enlarged display of the selected region of the graphical object.

19. A mobile electronic device, comprising:
means for displaying an image;
a plurality of input means for entering a user input;
control means for controlling the displaying of said image;
wherein the control means is configured to associate at least two regions of a graphical object comprised in an image displayed on said display each with an input means and to enlarge one of said regions of the graphical object in the displayed image upon activation of the associated input means.

20. A processor readable medium having processor-executable instructions for controlling a displaying of a graphical object on a display of a mobile electronic device, which when executed on a processor of the mobile electronic device perform steps comprising:
displaying an image comprising at least part of said graphical object on said display;
associating at least two regions of the graphical object comprised in the image each with a key of an input unit of said mobile electronic device; and
enlarging one of said regions of the graphical object in the displayed image upon actuation of the associated key.
